(19) United States
(12) Patent Application Publication
(10) Pub. No.: US 2019/0108503 A1
(43) Pub. Date: Apr. 11, 2019

(54) READING APPARATUS, READING METHOD, AND COMPUTER READABLE MEDIUM

(71) Applicant: TOSHIBA TEC KABUSHIKI KAISHA, Tokyo (JP)

(72) Inventors: Hidehiko MIYAKOSHI, Mishima Shizuoka (JP); Hidehiro NAITO, Mishima Shizuoka (JP)

(21) Appl. No.: 16/141,683

(22) Filed: Sep. 25, 2018

(30) Foreign Application Priority Data
Oct. 10, 2017 (JP) 2017-197191

(51) Int. Cl. G06Q 20/20; G06T 7/521; G06K 9/00; G06K 9/62

(52) U.S. Cl. CPC G06Q 20/208; G06T 7/521; G06F 3/0482; G06K 9/6215; G06K 9/00624

(57) ABSTRACT

According to one embodiment, there is provided a reading apparatus for registering one or more commodities. The reading apparatus includes a display, a storage device, an image sensor, and a processor. The processor is configured to control the image sensor to capture an image of one or more commodities and measure a distance to each of the commodities, select one of the commodities, the distance of which from the image sensor is the smallest, control the display to display the captured image such that the selected commodity is highlighted, and execute a registration process on the selected commodity using commodity information about the selected commodity retrieved from the storage device.

### CROSS-REFERENCE TO RELATED APPLICATION

This application is based upon and claims the benefit of priority from Japanese Patent Application No. 2017-197191, filed in Oct. 10, 2017, the entire contents of which are incorporated herein by reference.

### FIELD

Embodiments described herein relate generally to a reading apparatus, a reading method, and a computer readable medium.

### BACKGROUND

In the related art, a technique of object recognition is known to identify a target object using an image sensor device. In the object recognition, the feature data of the imaged object is calculated, and then compared with reference data.

Such an object recognition technique is used in a retail store for assisting a commodity registration process by identifying commodities or determining commodity candidates with a reading apparatus having the image sensor device.

In the registration process using the object recognition, an operator lifts commodities to be registered one by one from a basket or a register counter, and scans the lifted commodity in an image capturing area of the image sensor. When the reading apparatus detects the commodity in the image capturing area, the object recognition process begins with respect to the detected commodity.

In order to improve efficiency of the registration process, there is a demand for a reading apparatus that can start the object recognition even while the commodities to be registered are placed in a basket or on a register counter as it is.

### DESCRIPTION OF THE DRAWINGS

FIG. 1 is a block diagram illustrating an entire configuration of a POS system according to one embodiment.

FIG. 2 is an external view of a scanner.

FIG. 3 is an external view when an image capturing unit is provided separately from the scanner.

FIG. 4 is a block diagram illustrating a configuration of functions to be achieved by a CPU of the POS terminal.

FIG. 5 is a view illustrating a configuration example of a reading screen.

FIG. 6 is a view illustrating a configuration example of a screen when one commodity of commodity candidates is selected.

FIG. 7 is a view illustrating an example of a screen after a registered commodity is taken out from a shopping basket.

FIG. 8 is a flow chart illustrating an example of a procedure of a reading process being executed by the POS terminal.

### DETAILED DESCRIPTION

Embodiments provide a reading apparatus and a method capable of achieving efficiency of a registration process.

In general, according to one embodiment, there is provided a reading apparatus for registering one or more commodities. The reading apparatus includes a display, a storage device, an image sensor, and a processor. The processor is configured to control the image sensor to capture an image of one or more commodities and measure a distance to each of the commodities, select one of the commodities, the distance of which from the image sensor is the smallest, control the display to display the captured image such that the selected commodity is highlighted, and execute a registration process on the selected commodity using commodity information about the selected commodity retrieved from the storage device.

With reference to drawings attached as follows, one embodiment of a reading apparatus, a reading method, and a computer readable medium will be described in detail. In the embodiments hereinafter, an example in which a point of sales (POS) terminal being used in supermarkets, convenience stores, and the like is applied will be described, but the exemplary embodiments are not limited to this application example.

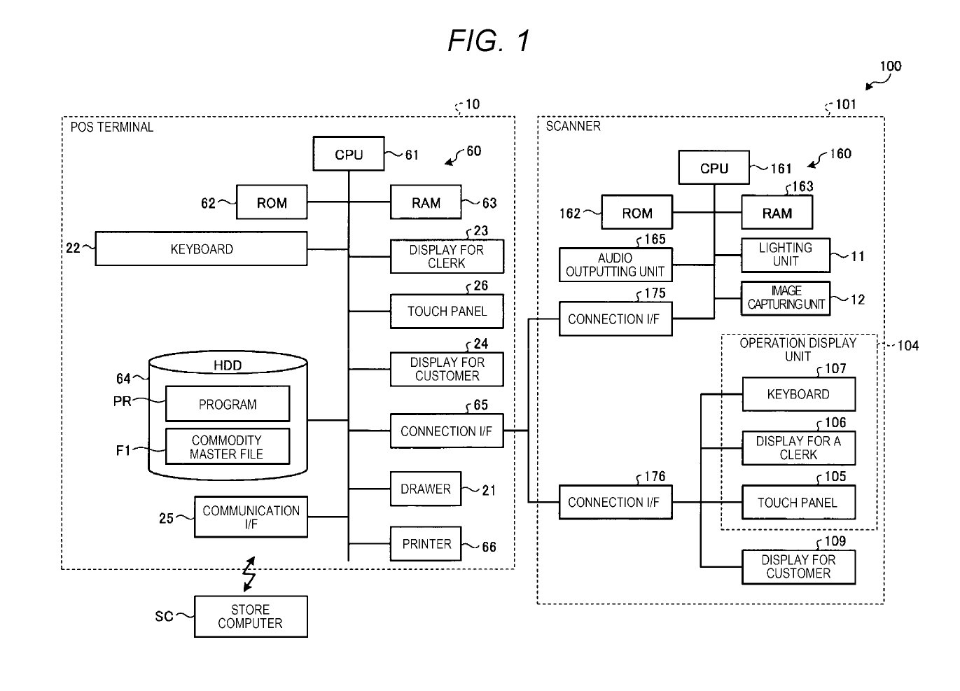

FIG. 1 is a block diagram illustrating an entire configuration of a POS system 100 according to an embodiment. The POS system 100 includes a POS terminal 10 and a scanner 101.

The POS terminal 10 includes a controller 60 which executes an information process. For example, the controller 60 is a micro-computer and comprises a central processing unit (CPU) 61 which controls each unit for executing various calculations, a read only memory (ROM) 62, and a random access memory (RAM) 63, which are connected thereto through a bus.

A drawer 21, a keyboard 22, a display for a clerk 23, a touch panel 26, and a display for a customer 24 are connected to the CPU 61 of the POS terminal 10 through various input and output circuits. The CPU 61 controls each of these units.

A hard disk drive (HDD) 64 is connected to the CPU 61 of the POS terminal 10. A program PR for executing a reading process of the embodiments described below and a commodity master file F1 are stored in the HDD 64. The commodity master file F1 is transmitted from a store computer SC at a predetermined timing such as before opening a store and is stored in the HDD 64.

The commodity master file F1 stores information relating to a commodity name, costs, types, and the like of a commodity correlated with a commodity code for identifying the commodity. In addition, the commodity master file F1 stores a captured image (reference image) of the commodity as reference data using object recognition. Also, the commodity master file F1 may store feature data extracted from the reference image, that is, data indicating color information, a shape of a surface, texture of the surface, and the like of the reference image as the reference data being used for the object recognition.

A communication interface (I/F) 25 for executing data communication with the store computer SC is connected to the CPU 61 of the POS terminal 10 through an input and output circuit (not illustrated). The store computer SC is provided at a back office of a store or the like. A HDD (not illustrated) of the store computer SC stores the commodity master file F1 being transmitted to the POS terminal 10.

Further, a connection I/F 65 is used for transmitting and receiving data between the scanner 101 and the CPU 61 of the POS terminal 10. The scanner 101 is connected to the connection I/F 65. In addition, a printer 66 which executes printing on a receipt or the like is connected to the CPU 61 of the POS terminal 10. The printer 66 prints a transaction detail of one transaction on a receipt under a control of the CPU 61.

The scanner 101 includes a controller 160 to which a CPU 161, a ROM 162, and a RAM 163 are connected through a bus. For example, the controller 160 is a micro-computer. The ROM 162 memorizes various programs being executed by the CPU 161. A lighting unit 11, an image capturing unit 12, an audio outputting unit 165, and the like are connected to the CPU 161 through various buses or I/Fs, and the CPU controls operations of these various units. The controller 160 is connected to the POS terminal 10 through a connection I/F 175.

The audio outputting unit 165 is an audio circuit, a speaker, or the like for generating alarm or the like which is set in advance. For example, the lighting unit 11 comprises a plurality of light emitting diodes (LEDs) which are arranged in a line shape. The lighting unit 11 performs pulse light emission by an emitting control signal being input to the lighting unit 11 and irradiates an image capturing area of the image capturing unit 12 with the light. Also, the lighting unit 11 may comprise other emitting elements.

The image capturing unit 12 is an image capturing device including an image sensor (also referred to as image capturing element) such as a charge coupled device (CCD) or a complementary metal-oxide semiconductor (CMOS) and an optical element such as lens. The image capturing unit 12 sequentially reads a frame image by the RAM 163 at a frame rate (i.e., the number of frames being read in one second) based on an image capturing control signal.

In addition, in an embodiment, the image capturing unit 12 (also referred to as a time-of-flight (TOF) camera) including a TOF function is used. For example, the TOF camera projects infrared rays on which frequency modulation is performed from infrared LEDs which are arranged in an array shape, and measures a phase of a modulation signal reflected from an object (i.e., article) in the field of view, such that a distance to the article is measured. The TOF camera is an image capturing unit capable of acquiring distance information in real time. The POS system 100 of an embodiment acquires the distance information by the TOF camera. Accordingly, an article present at the top of the shopping basket, that is, the article closest to the image capturing unit 12 can be identified and selected for subsequent registration. The image capturing unit 12 sequentially outputs image data correlated with the distance information, that is, the captured images to the POS terminal 10.

Also, the image capturing unit 12 may include an image sensor for acquiring a frame image and the TOF camera for acquiring the distance image respectively as a separate sensor device or may include one sensor device having both functions of the image sensor and the TOF camera.

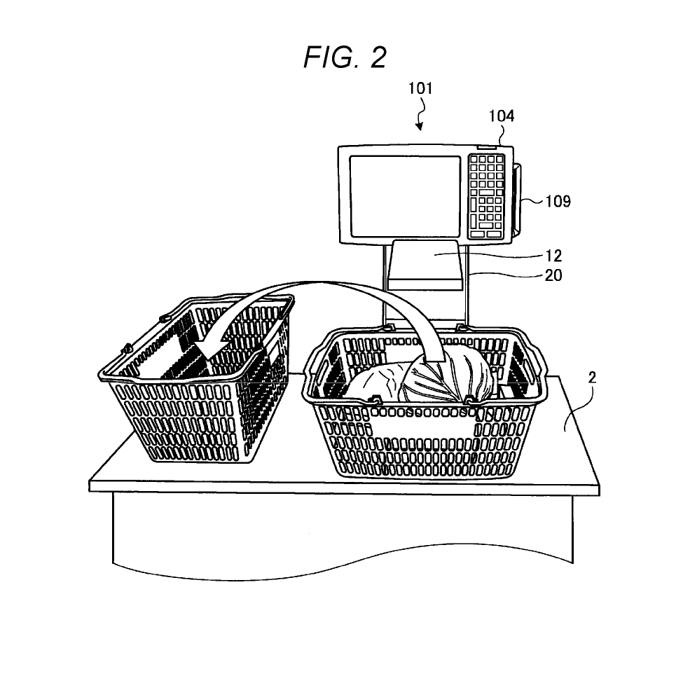

In addition, an operation display unit 104 for a clerk and a display for a customer 109 (also refer to FIG. 2) are connected to the CPU 161 through the connection I/Fs 175 and 176. Also, the operation display unit 104 for a clerk and the display for a customer 109 are connected to the CPU 61 of the POS terminal 10 through the connection I/F 176 and the connection I/F 65 of the POS terminal 10. The operation display unit 104 for a clerk includes a keyboard 107, a display for a clerk 106, and a touch panel 105 arranged on the display for a clerk 106.

For example, the display fora clerk 106 comprises a liquid crystal display and the touch panel 105 stacked on a liquid crystal surface. The display for a customer 109 may comprise a liquid crystal display, a line indicator or the like which is capable of displaying a plurality of rows, or the like.

Next, a structural configuration of the scanner 101 will be described.

FIG. 2 is an external view of the scanner 101. As exemplified in FIG. 2, the scanner 101 is provided and used on an upper surface of a packing table 2. The packing table 2 is a working table where a shopping basket, a commodity, and the like are displaced and used on an upper surface thereof, and is used as a register counter. The scanner 101 includes the operation display unit 104 for a clerk on an upper end of a flat plate type supporting portion 20. Also, the display for a customer 109 and the operation display unit 104 for a clerk are provided to be substantially back to back on an opposite side of the operation display unit 104 for a clerk.

In addition, the scanner 101 includes the image capturing unit 12 below a screen of the display fora clerk 106 on a front side when seen from an operator facing the operation display unit 104. A position (i.e., height) and an angle in an optical axis of the image capturing unit 12 is determined so that the entire contents inside the shopping basket disposed on the packing table 2 are included in an image capturing area of the image capturing unit 12. Also, at the time of operation, a commodity maybe directly disposed on the packing table 2 without using the shopping basket.

### Other Configuration Examples

Also, in FIG. 2, an example in which the image capturing unit 12 is held in front of the supporting portion 20 is described, but a providing position of the image capturing unit 12 is not limited thereto.

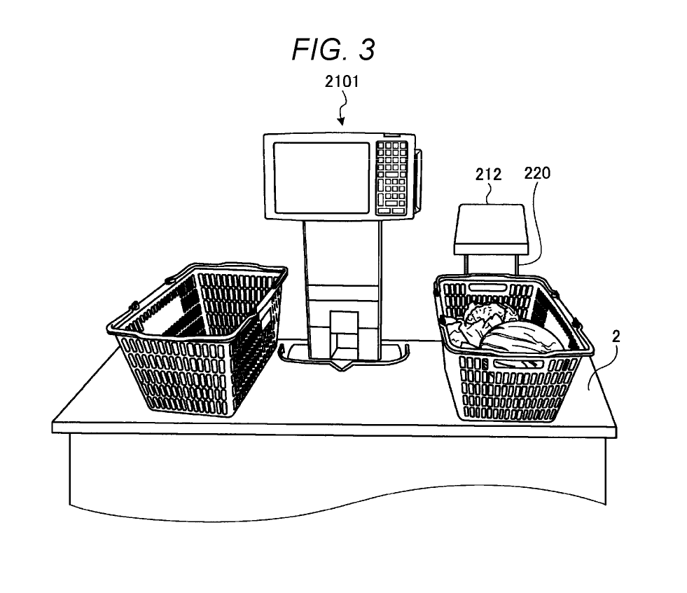

FIG. 3 is an external view when the image capturing unit is provided as a separate member from the scanner. In FIG. 2, a shopping basket which is a target to be read is placed in front of the scanner 101 and is read, but a placed position of the shopping basket can be appropriately changed. As illustrated in FIG. 3, the shopping basket, which is a target to be read and where unregistered commodities are placed, is placed on a right side of a scanner 2101, and a front of the scanner 2101 becomes an empty space. Also, operation may be performed when the shopping basket where registered commodities are placed is placed on a left side of the scanner 2101.

In accordance with such store operation, in FIG. 3, an image capturing unit 212 as a separate member from the scanner 2101 is arranged on the packing table 2 on the right side of the scanner 2101. That is, the image capturing unit 212 is arranged on an upper surface of the packing table 2 by the supporting portion 220 of the image capturing unit 212. A position (i.e., height) and an angle in an optical axis of the image capturing unit 212 is determined so that the entire contents inside the shopping basket which is a target to be read are included in an image capturing area. Also, a hardware configuration of the image capturing unit 212 and connection to other configurations of the scanner 2101 are the same as those described above. The image capturing unit 212 as illustrated in FIG. 1 is connected to the CPU 161 and the POS terminal 10 of the scanner 2101 through the connection I/F 175.

Also, placing of the shopping basket, which is a target to be read and in which unregistered commodities are placed, on a right side or a left side of the scanner 2101 can be appropriately changed depending on a layout of a store or the like. A right side and a left side may be switched different from FIG. 3, and the supporting portion 220 of the image capturing unit 212 may be provided on an upper surface of the packing table 2 on a left side of the scanner 2101.

Next, a program PR executed by the POS terminal 10 of an embodiment will be described. A software configuration can be applied to a configuration of any one of the scanners 101 and 2101 described above without differences, and thus reference numerals of configurations being executed in the scanner 101 will be applied and described hereinafter.

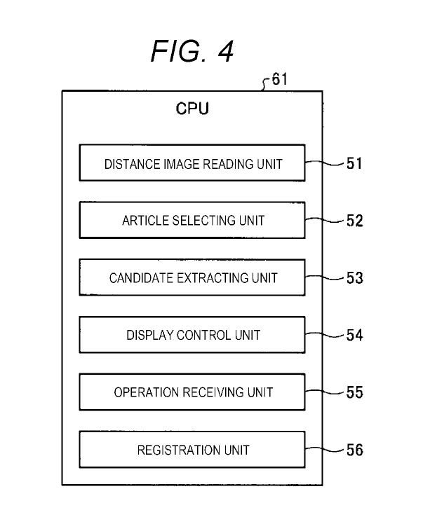

FIG. 4 is a block diagram illustrating a configuration of functions to be achieved by the CPU 61 of the POS terminal 10. The program PR (refer to FIG. 1) stored in the HDD 64 of the POS terminal 10 comprises a plurality of modules including a distance image reading unit 51, an article selecting unit 52, a candidate extracting unit 53, a display control unit 54, an operation receiving unit 55, and a registration unit 56 as illustrated in FIG. 4. The CPU 61 reads out the program PR from the HDD 64 (refer to FIG. 1), and loads each unit described above to a main storage device. Accordingly, each unit described above is generated in the main storage device.

Also, the program PR being executed by the POS terminal 10 of an embodiment is installed and provided in the HDD 64 in advance. Also, the program PR may be installed in the ROM 62 (refer to FIG. 1). The program PR being executed by the POS terminal 10 of an embodiment maybe recorded in a recording medium such as a CD-ROM, a flexible disk (FD), a CD-R, or a digital versatile disk (DVD) which is readable by a computer as a file in an installable type or an executable type.

Further, the program PR being executed by the POS terminal 10 of an embodiment may be also provided by being stored in a computer connected to a network such as the Internet and downloaded through the network. In addition, the program PR being executed by the POS terminal 10 of an embodiment may be provided or distributed through the network such as the Internet.

The distance image reading unit 51 reads the captured image (also referred to as a distance image) captured by the image capturing unit 12 from the RAM 63 of the POS terminal 10.

The article selecting unit 52 selects articles as a target of the registration process in an order of ascending a distance from the image capturing unit 12 based on the distance information. As an example, the article selecting unit 52 divides the distance image into a multilayered structure in each distance, and extracts the article which is recognized as a unit based on the distance information and position information (i.e., information indicating two-dimensional position). The article selecting unit 52 selects an article positioned on an uppermost layer which is the article closest to the image capturing unit 12 as a target article of the registration process.

Also, at the time of extracting or detecting the article, the article may be extracted by executing an edge detecting process or the like using a two-dimensional color image or a monochrome image which does not particularly include the distance information. In addition, the distance information, the position information, the edge detecting process, and the like may be appropriately combined with each other, and an order of combining each process is not particularly limited.

The candidate extracting unit 53 executes an object recognition process on an image of an article selected by the article selecting unit 52. The candidate extracting unit 53 extracts at least one candidate of a commodity (i.e., commodity candidates) similar to an article which is a target to be registered from the commodity master file F1 as a result of the object recognition process.

Also, the object recognition is a technique of identifying external features of a target article from captured image data and specifying types of the article and the like. The candidate extracting unit 53 extracts feature data indicating the external features from an image area of the article selected by the article selecting unit 52. The candidate extracting unit 53 calculates similarity obtained by collating the extracted feature data with data relating to feature data of a reference image of each commodity included in the commodity master file F1. The candidate extracting unit 53 extracts at least one commodity having a high similarity as a commodity candidate.

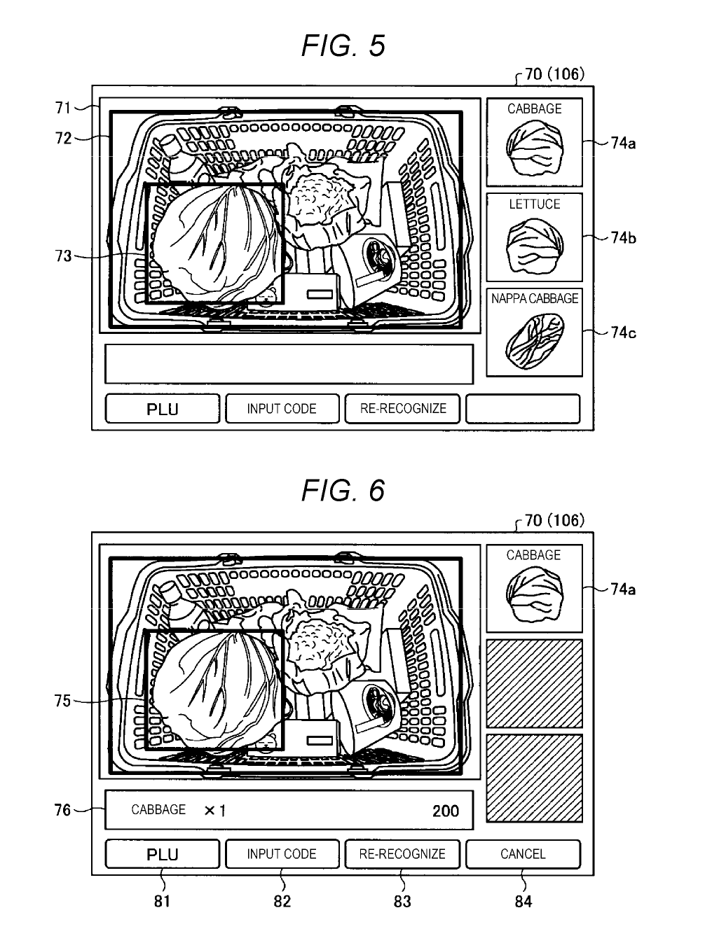

The display control unit 54 generates each display data item being output to the display for a clerk 23 and the display for a customer 24 of the POS terminal 10, and the display for a clerk 106 and the display for a customer 109 of the scanner 101, and controls a display process in each display. For example, the display control unit 54 controls the display for a clerk 106 of the scanner 101 to display a reading screen 70 (refer to FIGS. 5 to 7) at the time of executing the reading process on a commodity. A screen configuration example will be described later.

The operation receiving unit 55 receives input operations with respect to the keyboard 22 and the touch panel 26 of the POS terminal 10, and the keyboard 107 and the touch panel 105 of the scanner 101. For example, the operation receiving unit 55 receives an operation for selecting one commodity from the commodity candidates displayed on the display for a clerk 106 under control of the display control unit 54.

The registration unit 56 executes the registration process of articles in an order of ascending the distance from the image capturing unit 12. As an example of the registration process of the articles, the registration unit 56 executes a selling registration process of the commodities. That is, the registration unit 56 registers commodity candidates of which the operation receiving unit 55 received a selecting operation as a selling target commodity to be registered. That is, regarding the selected commodity candidate, the registration unit 56 reads commodity information, such as a commodity name, a type, or a cost thereof, from the commodity master file F1 and reads by a work memory for temporary registration of a target article to be registered. When a confirmation key or the like in the keyboard 22 of the POS terminal 10 is operated, the registration unit 56 confirms data relating to the temporary registration and finalizes the registration of the data in a sale data file (not illustrated). Also, the registration process of the article is not limited to the selling registration process of the commodity, and a process of registration by reading information from an article such as a card indicating a discount coupon or necessity of a plastic grocery bag or the like may be executed.

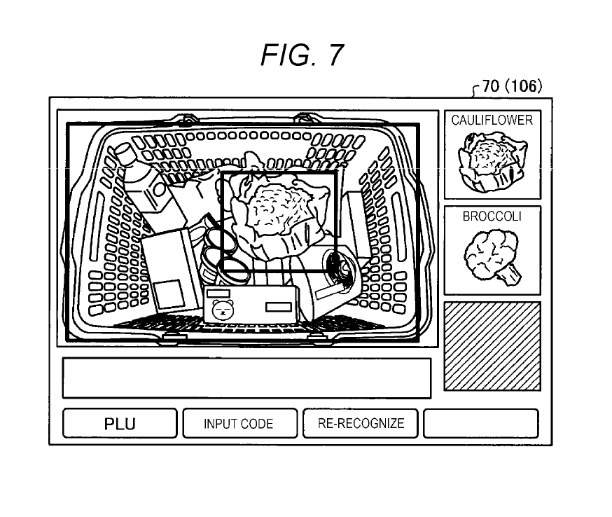

Next, with respect to FIG. 5 or 7, a configuration example and a transition example of a display screen will be described.

FIG. 5 is a view illustrating a configuration example of the reading screen 70. On the reading screen 70, a captured image 71 of the image capturing unit 12 is displayed in real time. The display control unit 54 controls the display for a clerk 106 to display a guide display (e.g., a guide line) 72 indicating a position where the shopping basket is placed in a display area of the captured image 71. The guide display 72 is easily recognized when being displayed by, for example, a colored frame or the like. As an example, the guide display 72 may be displayed by a yellow rectangular frame line.

When the guide display 72 is displayed on the screen as described above, the shopping basket can be placed so as to be fit into the image capturing area of the image capturing unit 12. In addition, even when a commodity is directly placed on the packing table 2 without using the shopping basket, the commodity can be placed so as to be fit into the image capturing area.

The display control unit 54 controls the display for a clerk 106 to display a target article to be registered which is selected by the article selecting unit 52 as an article discriminable in a captured image on the reading screen 70. For example, the display control unit 54 highlights the selected article by attaching a first identification mark 73 to an article which is a target to be registered. As an example, the first identification mark 73 substantially surrounds an image area of the article which is a target to be registered and may be configured as a colored frame or the like. Since shapes of commodities are various, a frame line may be not particularly rectangle, may be a circle or an ellipse, or may be appropriately changed depending on the shape of the commodity. In addition, since the first identification mark 73 is attached to an article of which a commodity is not specified yet, a frame line thereof maybe displayed as a dotted line, or may be displayed by blinking. Otherwise, the first identification mark 73 may be configured as a mark rather than a frame line, or the mark may be configured to include texts or illustrations.

In addition, the display control unit 54 controls the display for a clerk 106 to display at least one commodity candidate extracted by the candidate extracting unit 53, for example, a commodity name, a commodity illustration, or a photograph image from the commodity master file F1 as information indicating the commodity candidates. On the reading screen 70, a display on the right of the captured image 71 is used as a display area for displaying the commodity candidates. FIG. 5 illustrates an example in which three commodity candidates 74a to 74c are extracted as the commodity candidate similar to the article to which the first identification mark 73 is attached. The display control unit 54 controls the display for a clerk 106 to display illustrations corresponding to the commodity candidates 74a to 74c in a row from the top in an order of descending similarity. Also, when only one commodity candidate having high similarity is extracted, an illustration of the one commodity candidate is displayed.

FIG. 6 is a view illustrating a screen configuration example when one commodity is selected from the commodity candidates. When the operation receiving unit 55 receives a selecting operation with respect to the commodity candidate, instead of the first identification mark 73, the display control unit 54 attaches a second identification mark 75 different from the first identification mark 73 to the selected article as a target to be registered so as to highlight the article. As an example, when the first identification mark 73 is displayed as a red frame and one commodity candidate is selected, the display control unit 54 controls the display for a clerk 106 to display the second identification mark 75 as a blue frame. Otherwise, as the second identification mark 75, the inside of the frame is made to be shaded, and the specified article maybe displayed by being gray-out. Otherwise, a mark showing a text “completed” or the like is displayed as the second identification mark 75, and it may be clearly specified that a specifying process is completed.

In addition, the display control unit 54 maintains only an illustration of the selected commodity candidate 74a when one commodity candidate is selected, and makes illustrations of the non-selected commodity candidates 74b and 74c be gray-out.

In addition, when one commodity candidate is selected, the display control unit 54 reads commodity information correlated with the selected commodity candidate from the commodity master file F1, and displays the information on a reading information display area 76 with a quantity of commodities. Also, the display control unit 54 may control the display for a customer 109 to display the same information.

Also, as illustrated in FIG. 6, on the reading screen 70, a price look up (PLU) button 81, a code inputting button 82, a re-recognizing button 83, the cancel button 84, and the like are provided. The PLU button 81 allows an operator to start a process of selecting a commodity based on a commodity type or a commodity name by requesting the commodity master file F1. The code inputting button 82 allows the operator to input a commodity code through a ten-key of the keyboard 107 and starting a process of reading commodity information of the corresponding commodity from the commodity master file F1. The re-recognizing button 83 allows the operator to execute object recognition again when an appropriate commodity candidate is not selected or the like. The cancel button 84 allows the operator to cancel registration of the commodity after one commodity candidate is selected and the commodity information thereof is displayed on the reading information display area 76.

FIG. 7 is a view illustrating an example of a screen after the registered commodity is taken out from the shopping basket. When the article (e.g., a cabbage in example of FIG. 6), of which a commodity name is specified, surrounded by the second identification mark 75 (for example, blue frame) is taken out from the shopping basket, the article selecting unit 52 detects that the article is out of the frame. The display control unit 54 updates the reading screen 70, and deletes the operation parts of the commodity candidate 74a, information displayed on the reading information display area 76, and the like. The registration unit 56 outputs information such as a commodity name, the number thereof, and costs displayed on the reading information display area 76 to a POS terminal 10 side. In addition, the display control unit 54 controls the display for a clerk 23 of the POS terminal 10 to display the information such as a commodity name, the number thereof, and costs on a registration screen based on the information output from a scanner 101 side.

The article selecting unit 52 selects an article positioned on the uppermost layer as a target article on which a next registration process is executed, based on a captured image (i.e., distance image) and distance information after the article is framed-out. The display control unit 54 attaches the first identification mark 73 (for example, red frame) described above to the article selected by the article selecting unit 52 and displays the article. The candidate extracting unit 53 starts an object recognition process with respect to an image of the article selected by the article selecting unit 52, and extracts commodity candidates.

As described above, in an embodiment, the registered commodity is taken out from the shopping basket, and then the reading process for the next commodity is started automatically. Accordingly, efficiency of the reading process can be achieved.

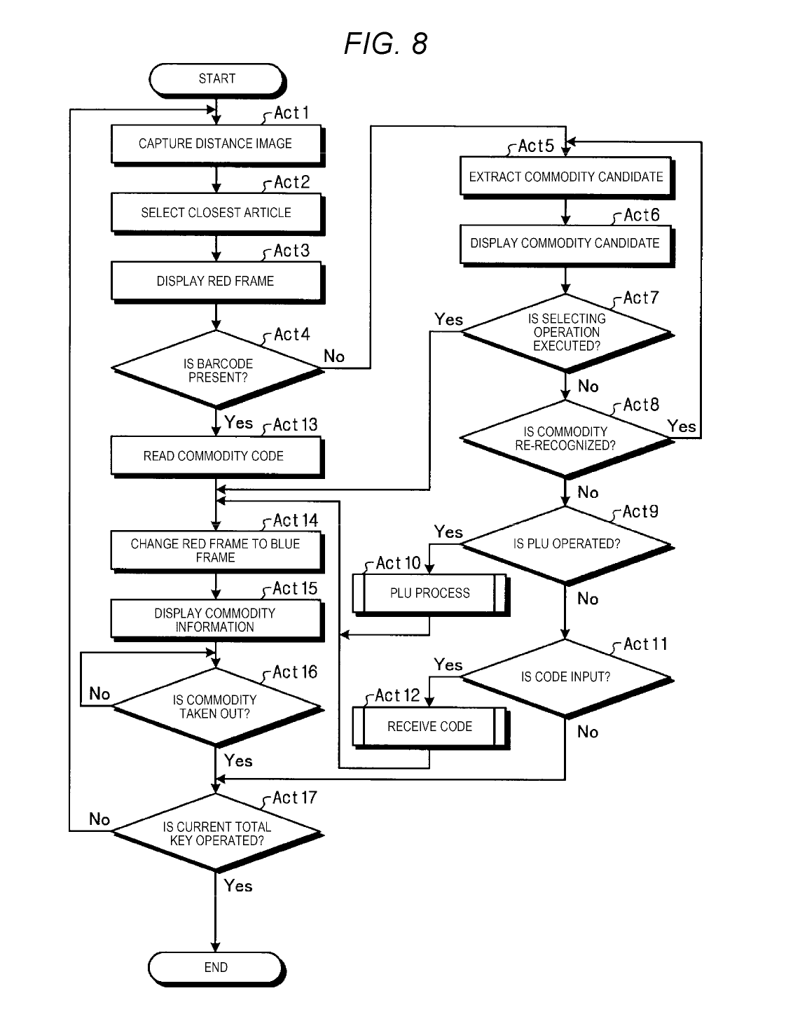

Next, an example of a procedure of the reading process being executed by the POS terminal 10 will be described. FIG. 8 is a flowchart illustrating an example of a procedure of the reading process being executed by the POS terminal 10.

The distance image reading unit 51 starts to take the captured image (i.e., distance image) of the image capturing unit 12 (Act 1). The article selecting unit 52 selects the article positioned on the uppermost layer as the article closest to the image capturing unit 12 based on the distance information (Act 2). The display control unit 54 attaches the first identification mark 73 (for example, red frame) to an image area of the article selected in Act 2 and displays (Act 3). The registration unit 56 determines whether or not an image of a code symbol such as a barcode is included in the image area of the article selected in Act 2 (Act 4).

If the code symbol is included (Yes in Act 4), the registration unit 56 decodes the code symbol and reads a commodity code (Act 13). In addition, the registration unit reads the commodity information corresponding to the commodity code from the commodity master file F1, and a procedure moves to Act 14.

If the code symbol is not detected (No in Act 4), the candidate extracting unit 53 executes the object recognition process on the image of the article selected in Act 2 and extracts the commodity candidates (Act 5). The display control unit 54 controls the display for a clerk 106 to display illustrations (e.g., icons) indicating the commodity candidates extracted in Act 5 on the reading screen 70 (Act 6). The operation receiving unit 55 determines whether or not a selecting operation with respect to any one of the commodity candidates is received (Act 7). If the operation receiving unit receives the selecting operation (Yes in Act 7), the registration unit 56 reads commodity information corresponding to the selected commodity candidate from the commodity master file F1, and the procedure moves to Act 14.

When operation receiving unit does not receive the selecting operation (No in Act 7), the operation receiving unit 55 determines whether or not the re-recognizing button 83 (refer to FIG. 6) is operated (Act 8). When the re-recognizing button 83 is operated (Yes in Act 8), the procedure moves to Act 5, and the candidate extracting unit 53 executes the object recognition process again and retries extracting of the commodity candidates. Meanwhile, if the re-recognizing button 83 is not operated (No in Act 8), the operation receiving unit 55 determines whether or not the PLU button 81 is operated (Act 9).

When the PLU button 81 is operated (Yes in Act 9), the registration unit 56 starts a PLU process of selecting a commodity from the commodity master file F1 (Act 10). Regarding the PLU process, a technique generally used in the related art may be applied. That is, the registration unit 56 receives selection of the commodity through a commodity selecting screen or the like which is hierarchically constituted by commodity types. Also, the registration unit 56 reads the commodity information about the selected commodity from the commodity master file F1, and the procedure moves to Act 14.

If the PLU button 81 is not operated (No in Act 9), the operation receiving unit 55 determines whether or not the code inputting button 82 is operated (Act 11). If the code inputting button 82 is not operated (No in Act 11), the procedure moves to Act 17. When the code inputting button 82 is operated (Yes in Act 11), the registration unit 56 starts a code receiving process in which a commodity code is directly input from a ten-key (Act 12). Regarding the code receiving process, a technique being generally used in the related art may be applied. That is, when the commodity code is input through the ten-key or the like of the keyboard 107, the registration unit 56 reads the commodity information corresponding to the commodity code from the commodity master file F1, the procedure moves to Act 14.

In Act 14, the display control unit 54 controls the display for a clerk 106 to display the first identification mark 73 (for example, red frame) instead of the second identification mark 75 (for example, blue frame). The display control unit 54 controls the display for a clerk 106 to display the commodity information read from the commodity master file F1 in Yes in Act 7, Act 10, or Act 12 on the reading information display area 76 (Act 15). The article selecting unit 52 determines whether or not the article on the uppermost layer to which the second identification mark 75 is attached is taken out from the shopping basket, and the image of the article is frame-out from an area of the guide display 72 (refer to FIG. 5) (Act 16). While the article is not taken out (No in Act 16), the procedure returns to Act 16 and standby.

When the article is taken out (Yes in Act 16), the procedure moves to Act 17. The operation receiving unit 55 determines whether or not a current total key in the keyboard 107 is operated (Act 17). While the current total key is not operated (No in Act 17), the procedure returns to Act 1, the reading process of the commodities is continually executed until the shopping basket is empty. When the current total key is operated (Yes in Act 17), the reading process is finished, an operator moves to the front of the POS terminal 10 from the front of the scanner 101, and executes a calculation process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, a function included in the controller 160 of the POS terminal 10 described above may be included in the controller 160 of the scanner 101. That is, the scanner 101 as the reading apparatus of the aforementioned embodiments may be applied, and the controller 60 of the scanner 101 may include functions the same as those of the distance image reading unit 51, the article selecting unit 52, the candidate extracting unit 53, the display control unit 54, the operation receiving unit 55, and the registration unit 56. Also, in an embodiment, it may be considered that the scanner 101 reads the commodity information from the commodity master file F1 and displays the information on the display for a clerk 106 or the display for a customer 109 of the scanner 101 so as to execute a process of registering the commodity information.

In addition, in the above-description, the example in which the articles selected in an order of ascending the distance are set to be a target of the object recognition process is exemplified, the selected article may be set to be a target of other image processes. As the other image process, for example, as exemplified in FIG. 8, there is a code reading process, that is, a process of reading from a code symbol. In addition, as another example, there is an optical character recognition (OCR) process. That is, with respect to an image of the article selected by the article selecting unit 52, character information thereof may be read by the OCR, the commodity information may be read by requiring the character information to a commodity master, and the registration process may be executed. In addition, for example, the character information or code information with respect to an article such as a card representing a coupon, or purchase of a plastic grocery bag or necessity of a plastic grocery bag is read, and a cost discount process by requiring master data (information storage unit) or the registration process such as adding costs or adding points may be executed.

In addition, the embodiments described above may be applied to a self-checkout device (self-checkout POS). In this case, for example, the image capturing unit 12 is provided on the top of a load table on which a shopping basket where unregistered commodities are placed is placed, an inside of the shopping basket may be captured from the top of the load table.

In addition, in the above-description, the commodity is captured from the top (diagonally upward), but the commodity may be horizontally captured, that is, may be captured from a side surface. In addition, a plurality of image capturing units 12 may be used.

As described above, in the embodiments, since articles are set to be a target in an order of ascending the distance from the image capturing device, even when a plurality of commodities are included in the captured image, the articles is automatically selected one by one so as to be settable as a target of the registration process. That is, even when an operator does not hold and scan the commodity one by one with the image capturing device, a process such as the object recognition, the image process, and cord-reading can be started. Accordingly, according to the embodiments, the reading apparatus and a method capable of achieving efficiency of the registration process can be provided.

In addition, a work of holding a heavy commodity to an image capturing area is a work for giving a burden on an operator, and when heavy commodities such as cabbages are subject to sale, there are some cases in which several tens of heavy commodities may be required to be registered per day, and thus the operator asks reducing of the burden. With respect to that, according to the embodiments, since the commodities can be selected one by one in an order of ascending the distance from the image capturing device, even when a target to be registered is placed inside a basket or on a register counter as it is, the object recognition process can be started. Accordingly, according to the embodiments, reduction of the burden on the operator at the time of a registration work can be achieved.

What is claimed is:

1. A reading apparatus for registering one or more commodities, comprising:
a display;
a storage device;
an image sensor; and
a processor configured to:
control the image sensor to capture an image of one or more commodities and measure a distance to each of the commodities;
select one of the commodities, the distance of which from the image sensor is the smallest;
control the display to display the captured image such that the selected commodity is highlighted; and
execute a registration process on the selected commodity using commodity information about the selected commodity retrieved from the storage device.

2. The reading apparatus according to claim 1, wherein
the selected commodity is highlighted with a colored frame.

3. The reading apparatus according to claim 1, wherein
the processor is configured to:
determine one or more candidate commodities by executing object recognition on the selected commodity; and
control the display to display candidate information about the candidate commodities retrieved from the storage device.

4. The reading apparatus according to claim 3, wherein
the candidate information is displayed by an image illustrating each of the candidate commodities.

5. The reading apparatus according to claim 4, wherein
when receiving an input of selecting one of the candidate commodities, the processor changes an aspect of the highlighting for the selected commodity.

6. The reading apparatus according to claim 5, wherein
the selected commodity is highlighted with a colored frame, and
in response to the input, the color of the frame is changed.

7. The reading apparatus according to claim 5, wherein
the processor is configured to:
retrieve the commodity information correlated with the selected candidate commodity from the storage device; and
control the display to display the commodity information about the selected candidate commodity.

8. The reading apparatus according to claim 7, wherein
the processor is configured to:
control the image sensor to continue to capture the commodities;
stop highlighting the selected commodity when the selected commodity disappears from the captured image;
select another commodity, the distance of which from the image sensor is the smallest among the commodities except the disappeared commodity; and
control the display to display the captured image such that the selected other commodity is highlighted.

9. The reading apparatus according to claim 1, wherein
the storage device stores the commodity information associated with a predetermined code, and
when the captured image includes a code symbol on the selected commodity, the processor executes the registration process using the predetermined code retrieved from the code symbol.

10. The reading apparatus according to claim 1, wherein
the image sensor measures the distance to each of the commodities put in a shopping basket.

11. A reading method carried out by a reading apparatus for registering one or more commodities, the method comprising:
capturing with an image sensor an image of one or more commodities and measure a distance to each of the commodities;
selecting one of the commodities, the distance of which from the image sensor is the smallest;
displaying on a display the captured image such that the selected commodity is highlighted; and
executing a registration process on the selected commodity using commodity information about the selected commodity retrieved from a storage device.

12. The reading method according to claim 11, wherein the selected commodity is highlighted with a colored frame.

13. The reading method according to claim 11, further comprising:
determining one or more candidate commodities by executing object recognition on the selected commodity; and
displaying candidate information about the candidate commodities retrieved from the storage device.

14. The reading method according to claim 13, wherein
the candidate information is displayed by an image illustrating each of the candidate commodities.

15. The reading method according to claim 14, further comprising
when an input of selecting one of the candidate commodities is received, changing an aspect of the highlighting for the selected commodity.

16. The reading method according to claim 15, wherein
the selected commodity is highlighted with a colored frame, and
in response to the input, the color of the frame is changed.

17. The reading method according to claim 15, further comprising
retrieving the commodity information correlated with the selected candidate commodity from the storage device; and
displaying the commodity information about the selected candidate commodity.

18. The reading method according to claim 17, further comprising:
continuing to capture the commodities;
stopping highlighting the selected commodity when the selected commodity disappears from the captured image;
selecting another commodity, the distance of which from the image sensor is the smallest among the commodities except the disappeared commodity; and
displaying on the display the captured image such that the selected other commodity is highlighted.

19. The reading method according to claim 11, wherein
the storage device stores the commodity information associated with a predetermined code, and
the method further comprises, when the captured image includes a code symbol on the selected commodity, executing the registration process using the predetermined code retrieved from the code symbol.

20. Anon-transitory computer readable medium storing a program causing a computer to execute a method of registering one or more commodities, the method comprising:
capturing with an image sensor an image of one or more commodities and measure a distance to each of the commodities;
selecting one of the commodities, the distance of which from the image sensor is the smallest;
displaying on a display the captured image such that the selected commodity is highlighted; and
executing a registration process on the selected commodity using commodity information about the selected commodity retrieved from a storage device.
